(19) United States
(12) Patent Application Publication
(10) Pub. No.: US 2022/0254273 A1
(43) Pub. Date: Aug. 11, 2022

(54) FRACTAL ROUTINES BASED MENTORING AND COLLABORATION PLATFORM FOR CORPORATE LEARNING & DEVELOPMENT

(71) Applicant: TINY MAGIQ INNOVATIONS PRIVATE LIMITED, Kancheepuram Chennai (IN)

(72) Inventors: Sukumar RAJAGOPAL, Kancheepuram Chennai (IN); Kumaran ANANDAN, Kancheepuram Chennai (IN)

(21) Appl. No.: 17/603,388

(22) PCT Filed: Apr. 12, 2020
(86) PCT No.: PCT/IN2020/050348

§ 371 Date: Oct. 13, 2021

(30) Foreign Application Priority Data
Apr. 19, 2019 (IN) 201941015702

(51) Int. Cl. G09B 19/00; G06Q 50/20

(52) U.S. Cl. CPC G09B 19/00; G06Q 50/2057

(57) ABSTRACT

A fractal routine-based mentoring and transformation platform for corporate training by decomposing higher order skills into plurality of tiny fractals for effective development of higher order skills or mindset among corporate performers. The proposed approach has at least one mindset fractal module which deals with the human behaviour related (daily routine) mentoring/training aspect of the employee/trainee. At least one skill/method fractal module which deals with the functional and technical skill/method related mentoring/training aspect of the employee/trainee. The mindset fractal module and skill/method fractal module effectively decompose higher order skills into tiny fractals which are common across many of the higher order skills and thereby provide an effective transformation platform for employees to increase their productivity at work.

### TECHNICAL FIELD

Embodiments are generally related to the mentoring, collaboration and transformation platforms and tools. Embodiments are also related to behaviour training and modelling applications. Embodiments are additionally related to corporate L&D and mentoring platforms and applications. Embodiments are particularly related to a fractal routines-based mentoring and transformation platform for corporate L&D by decomposing higher order skills into a plurality of tiny fractals for effective development of higher order skills or mindset among employees of corporate organizations. Embodiments are particularly related to leveraging the subconscious mind (11 million packets of information per second processing speed) to accelerate the process of learning soft skills. Typically learning programs target the conscious brain which has limited speeds (40 packets of information per second)

### BACKGROUND OF THE INVENTION

With the advent of modern global business environment, several technological and economic factors are bringing about a change in business and educational paradigms worldwide. Over the past few decades, corporate focus has transitioned from physical assets and production to intellectual capital and knowledge management. In general, the intellectual capital is largely held in a company's employees. To maximize the intellectual value, companies are investing large sums of money in training and mentoring exercises directed at information dissemination to and between employees and which ensure that employees are up to date with changing business landscapes and practices.

Considerable research over the years has been focused on determining the cost to businesses to deal with soft skills and productivity of the employees. In most organizations (large and small), Learning & Development (L&D) is a critical function. L&D for hard skills—functional and technical skills is well understood, effectively delivered & measured because they are directly applicable to the jobs the people in an organization perform. For example, in a retail organization the effectiveness of a training program for checkout clerks can be easily measured using simple measurement techniques such as throughput, error rate etc. Majority of research shows that soft skills enablement is the priority for organizations. But in comparison to hard skills, both delivery & effectiveness of soft skills enablement is rife with a variety of problems

Research into the causes of lack of soft skills and self-management has clearly defined the problems and cost to a corporation but has failed to develop any comprehensive set of tools or solution that an employer can use to repair the problem. Most of these problems are associated with the day to day practice of the concepts learnt post the training program.

Currently, employers have no comprehensive set of products or ‘tools’ that can be used to modify what their employees do routinely on their jobs that are giving rise to work place presenteeism. Majority of the prior art solutions are medically based solutions to address the suffering of an employee which are often expensive and have a degree of side effects. The research further continues on the habit related problems of employees such as, but not limited to, sleep, stress, and fatigue in the employee's lives.

Based on the foregoing a need therefore exists for an improved approach for mentoring and training the employees in soft skills and inner management of employees. Also, a need exists for an improved fractal routines-based mentoring, collaboration and transformation platform for corporate training by decomposing higher order skills into a plurality of tiny fractals for effective development of higher order skills or mindset among corporate performers, as discussed in greater detail herein. The fractal routines approach allows the learner to leverage the subconscious mind to accelerate learning.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

One aspect of the disclosed embodiments is to provide an improved approach for mentoring and training on soft skills for employees.

Another aspect of the disclosed embodiments is to provide an improved fractal routine-based solution for soft skills training and mentoring.

Yet another aspect of the disclosed embodiments is to provide an improved fractal routines-based mentoring and transformation platform for corporate training by decomposing higher order skills into a plurality of tiny fractals for effective development of higher order skills or mindset among corporate performers.

The aforementioned aspects and other objectives and advantages can now be achieved as described herein. A fractal routine-based mentoring, collaboration and transformation platform for corporate training by decomposing higher order skills into plurality of tiny fractals for effective development of higher order skills or mindset among corporate performers. The proposed approach has at least one mindset fractal module which deals with the human behaviour related (daily routine) mentoring/training aspect of the employee/trainee. At least one skill/method fractal module which deals with the functional and technical skill/method related mentoring/training aspect of the employee/trainee. Higher order skills can be decomposed into mindset fractal modules and skill/method fractal modules. This enables employees undergoing training programs using this model (Fractal Routines) to practice the concepts on a daily basis thereby routinizing them. Because of the fine-grained nature of the fractal routines, it is easier to transfer the experiential knowledge gained from practicing them to other employees much more easily thereby providing an effective transformation platform for employees to rapidly increase their productivity at work.

The approach proposed herein deals with key higher order skills such as for example, but not limited to Strategic Orientation, Client Focus, Effective Communication, Transformative Change Management, Breakthrough Innovation, Managing Teams, Building Collaborative Relationships with respect to the employee/trainee. The transformation and training platform enable the trainee to “Asking Curious Questions (CQA) which is a fractal skill that enables the trainee to be empathetic, ask better questions, be more consultative, be a better listener and be more innovative. The CQA can be implemented with people from different cultures and nationalities and it does enable the effectiveness in all the higher order skills. Similarly, for negotiation skills which is another skill that is common to the higher order skills, “Ask For Something (AFS)” enables the trainee to excel in negotiating skill such as, asking for discount in fixed price shops that builds his/her/their ability to ask for things in high stakes scenarios. With respect to mindsets, an “Intention Orientation” module enables the acquisition of other mindsets (like Growth Mindset) over time. The proposed approach can be adapted to develop a wide range of fractals and modules such as for example, but not limited to, Traffic Light Model, Happy Bullocks, Transformative Collaboration, Transformative Delegation, Transformative Innovation which helps in decomposing higher order skills into plurality of fractals for effective development of higher order skills or mindset among corporate performers.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A fractal routine-based mentoring and transformation platform for corporate training by decomposing higher order skills into a plurality of fractals for effective development of higher order skills or mindset among corporate performers. The proposed approach has at least one mindset fractal module which deals with the human behaviour related (habit/daily routine) mentoring/training aspect of the employee/trainee. At least one skill/method fractal module which deals with the functional and technical skill/method related mentoring/training aspect of the employee/trainee. The mindset fractal module and skill/method fractal module effectively decompose higher order skills into tiny fractals which are common across many of the higher order skills and thereby provide an effective transformation platform for employees to increase their productivity at work.

Every organization has a competency map for the soft skills needed for each of the roles performed by the people in the organization. For example—Example A—a competency map for a leadership role in an organization has 7 skills—Strategic Orientation, Client Focus, Effective Communication, Change Management, Innovation, Managing Teams, Building Collaborative Relationships. And each of these 7 skills have a proficiency Level 1 (novice) to Level 4 (Expert). Depending on the seniority of the leadership role, the proficiency requirements will be adjusted. All these 7 skills are higher order skills and a typical organization designs one program to cover one of these skills or maybe two of these skills together. Therefore, the organization needs to design at least 5 programs to cover all these 7 skills. If each program is a 1- or 2-day instructor-led program, the leaders of the organization need to be away from their jobs for 7-10 days just to learn these 7 skills for them to be effective. Even if the program is delivered using e-learning the number of learning hours needed remains the same more or less. Whereas research shows that getting employees to spare time for learning1 is the biggest challenge L&D functions face. Experts say that employees don't want to spend more than a few minutes every day for learning. How can we dramatically reduce the time spent on learning such that it is only a few minutes per day, while also maximizing effectiveness?

A vast majority of the soft skills need a mindset change as well. And mindset changes are hard to effect using instructor led models or e-learning models. How do we effect mindset change with the same constraint of few minutes per day of learning?

Post-delivery of the soft skills enablement programs, anecdotal experience shows that most participants simply forget the learnings from the program because there is no easy way for the participants to apply the learnings to their job and in most cases, there is also no follow up to ensure that the learnings are being applied on the job. While some organizations have instituted action learning models, they have had only limited effectiveness because action learning projects don't change behaviour at a fundamental level. How do we change behaviour at a fundamental level using the learnings from a soft skills program? For example, how can we ensure that the participants of an empathy program are demonstrating empathy on the job and that it has had a positive impact on their job output? In other words, how can we design programs that gets the soft skills program to Level 4 (Results) in the Kirkpatrick Model3? [The typical soft skills program doesn't go beyond Level 2. Level 1—Reaction, Level 2—Learning, Level 3—Behaviour Change, Level 4—Results].

The approach proposed herein deals with key higher order skills such as for example, but not limited to Strategic Orientation, Client Focus, Effective Communication, Change Management, Innovation, Managing Teams, Building Collaborative Relationships with respect to the employee/trainee. The transformation and training platform enable the trainee to “Asking Curious Questions (CQA) which is a fractal skill that enables the trainee to be empathetic, ask better questions, be more consultative, be a better listener and be more innovative. The CQA can be implemented with people from different cultures and nationalities and it does enable the effectiveness in all the higher order skills.

Similarly, for negotiation skills which is another skill that is common to the higher order skills, “Ask For Something (AFS)” enables the trainee to excel in negotiating skill such as, asking for discount in fixed price shops that builds his/her ability to ask for things in high stakes scenarios. With respect to mindsets, an “Intention Orientation” module enables the acquisition of other mindsets (like Growth Mindset) over time. The proposed approach can be adapted to develop a wide range of fractals and modules such as for example, but not limited to, Traffic Light Model, Happy Bullocks, Collaborative Problem Solving, Commit & Deliver which helps in decomposing higher order skills into plurality of tiny fractals for effective development of higher order skills or mindset among corporate performers.

The fractal routines approach covers 10 aspects of influencing the subconscious to accelerate learning by tapping into the 11 million packets per second processing power of the subconscious mind as opposed to the 40 packets of information per second processing power of the conscious mind. The 8 aspects are: 1. Executing the fractal in the same sequence (say after sitting in the office chair in the morning everyday) 2. Massively repeated by doing it daily or multiple times daily 3. Fine grained short duration actions (each Fractal CQA, AFS . . . is fine grained) instead of coarse grained long duration actions 4. Intention orientated—aligning with the intention 5. Tactile—movement based as opposed to thinking based 6. Visualization—in line with a visualized future state 7. Reflection—doing the action in a reflective state of mind 8. Musical/Rhythmic—each fine grained action has up & down characteristic like music. 9. Conscious Breathing—breathing in and out consciously while doing the task increases its importance in the subsconscious. 10. Journaling—journaling the practice of the fractal everytime is another way to increase the importance in the subconscious.

As the participants journal their actions based on the fractal routine, the subconscious programming that changes the mindset takes root. The mentors can also provide micro-mentoring in response to the journal entry posted by a mentee making the mentoring/coaching process much more effective. And since the journaling is done using our proprietary mobile software Magiq Spark, other mentees can also learn from the journal entries of others as well as from the micro-mentoring provided by the mentors. This type of group or social learning is another important way by which learning gets accelerated.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the field.

I claim:

1. A fractal routines-based mentoring and collaboration system for corporate learning and development, said system comprising:
at least one mindset fractal module which deals with the human behavior related (daily routine) mentoring/training aspect of the employee/trainee;
at least one skill/method fractal module which deals with the functional and technical skill/method related mentoring/training aspect of the employee/trainee,
wherein the mindset fractal module and the skill/method fractal module is used for training people by decomposing higher order skills into plurality of tiny fractals for effective development of higher order skills or mindset.

2. The system as claimed in claim 1, wherein fractal modules and skill/method fractal modules are formed by decomposing higher order skills, wherein the fractal modules and skill/method fractal module enables employees undergoing training programs to practice the concepts on a daily basis thereby routinizing them.

3. The system as claimed in claim 1, wherein fractal modules and skill/method fractal modules are used to transfer the experiential knowledge gained from practicing them to other employees much more easily, thereby providing an effective transformation platform for employees to rapidly increase their productivity at work.

4. The system as claimed in claim 1, wherein the platform enables the trainee to asking Curious Questions (CQA) which is a fractal skill that enables the trainee to be empathetic, ask better questions, be more consultative, be a better listener and be more innovative.

5. The system as claimed in claim 1, wherein the Curious Questions (CQA) can be implemented with people from different cultures and nationalities and it does enable the effectiveness in all the higher order skills.

6. The system as claimed in claim 1, wherein the platform enables the trainee to develop Ask For Something (AFS) for negotiation skills which enables the trainee to excel in negotiating skills that builds an ability to ask for things in high stakes scenarios.

7. The system as claimed in claim 1, wherein the platform comprises an Intention Orientation module which enables the acquisition of other mindsets over time to be adapted to develop a wide range of fractals and modules.

8. The system as claimed in claim 1, wherein the platform can be used for dealing with at least of the following key higher order skills: Strategic Orientation; Client Focus; Effective Communication; Transformative Change Management; Breakthrough Innovation; Managing Teams; and Building Collaborative Relationships with respect to the employee/trainee.
